(19) United States
(12) Patent Application Publication
(10) Pub. No.: US 2001/0027525 A1
(43) Pub. Date: Oct. 4, 2001

(54) Remote access device and system

(76) Inventor: Richard Andrew Gamlin, Solihull (GB)

Correspondence Address: Intellectual Property/Technology Law, P.O. Box 14329, Research Triangle Park, NC, 27709, US

(21) Appl. No.: 09/822,135

(22) Filed: Mar. 30, 2001

(30) Foreign Application Priority Data
Apr. 1, 2000 (GB) 0007992.1

(51) Int. Cl. G06F 11/30; G06F 12/14

(52) U.S. Cl. 713/200

(57) ABSTRACT

This invention relates to a remote access device and system enabling the delivery of goods to unoccupied locations or receptacles at private domestic dwellings, or at business car parks or other public areas. According to the invention there is provided a remote access device comprising: a locking means, a communication means for receiving information from a remote location, a data entry means for enabling data input at the device, a data output means for enabling data output at the device, and a control means connected to each of the locking means, communication means, data entry means and the data output means. There is also provided a method of operating a remote access system incorporating a remote access device.

### FIELD OF THE INVENTION

This invention relates to a remote access device and system. The invention is likely to find its greatest utility in relation to the delivery of goods to unoccupied locations or receptacles at private domestic dwellings, or at business car parks or other public areas. Most of the following description will relate to the delivery of goods to an unoccupied private location; however, the use of the device and system for other remote access purposes is not thereby excluded.

### BACKGROUND TO THE INVENTION

The number and volume of products being purchased over the telephone and by way of the internet is increasing significantly. The number and volume of products being delivered to customer's homes or other delivery addresses is therefore increasing correspondingly.

The majority of deliveries are made by commercial delivery companies, and these companies delivery primarily during the working day. Often, the customer is absent from his or her home or other delivery address during the working day, or in particular is absent at the time the delivery is attempted.

It is therefore becoming an increasing concern that deliveries cannot be made “first time”, and repeated attempts have to be made, or else the customer has to arrange for the delivery to be made at a time and a place when he or she is present at the delivery address.

It is desired to provide a remote access device and system which will permit the delivery driver access to a secure location at the delivery address even whilst the customer is absent; the customer can subsequently access the location to retrieve the delivered product(s). A delivery may be made to the customer whether or not the customer is actually present at the delivery location.

### DESCRIPTION OF THE PRIOR ART

International patent application WO 97/41542 of Porter discloses a storage device and method for the delivery of goods to (and pick-up of goods from) an unoccupied location. The disclosed device comprises a locking means to control access to the location, a control means controlling operation of the locking means, a memory for storing a number of vendor codes, and a data entry means by which a delivery driver may input a code to the supplier, the location being accessible to the delivery driver if the inputted supplier code matches a supplier code stored within the memory. The device also includes a communication device by way of which a message can be transmitted to a remote location (e.g. the customer's home or business) informing the customer that a delivery has been made.

This device and method suffers a number of disadvantages, Firstly, whilst it is envisaged that each user or vendor can set up a different vendor code for each storage device, in practice it is unlikely that a delivery driver would wish to record or memorise a number of different vendor codes when planning deliveries to a number of separate locations. Accordingly, it is likely that the same vendor code will enable access to a number of different locations. An unscrupulous delivery driver may therefore be able to obtain access to many storage devices over perhaps a large territory, at any time of his or her choosing, in the hope that some of those storage devices contain deliveries which can be stolen.

Also, should a supplier code become known to an unlawful person, it will be necessary for the supplier to contact all of its customers using that supplier code to alert them to change the supplier code. Many articles might have been stolen by the unlawful person before all of the supplier codes have been changed. In any event, the change of a supplier code must be coordinated with all of the customers using that supplier code so that no customer is unable to receive deliveries because he or she has failed to change to the new supplier code.

The Porter document seeks to reduce the likelihood or severity of unauthorised entry by the unscrupulous or unlawful by including the requirement for insertion of an “employee code” which is unique to a particular delivery driver. However, an unlawful person who has knowledge of the supplier code might be able successfully to guess an employee code, or might otherwise become aware of the employee code, enabling unauthorised access to a large number of locations, over perhaps a large geographical area.

The requirement that the device can store a supplier code for each supplier who might be given access to the location, and the requirement for the device to store a large number of employee codes (if utilised) necessitates a large memory, increasing the cost of the device. In practice, measures have to be taken to ensure that the codes are maintained in the memory in the event of a power failure, or that the codes can readily be re-entered if required.

Notwithstanding the provision of a communication means to communicate the delivery to the customer, there is no confirmation of delivery issued to the driver, and it is believed that many suppliers consider this to be a significant disadvantage of the device and system of Porter. Thus, a delivery driver would ordinarily seek to obtain a signature or other record that a delivery has been made, and the obtaining of such record effectively confirms the transferrence of the goods from the supplier to the customer. With the device and system of Porter, however, the delivery driver will not know if the communication means is operating successfully or at all, and suppliers may not wish to make deliveries to locations at which no confirmation of delivery may be available.

### SUMMARY OF THE INVENTION

The present invention seeks to reduce or avoid the disadvantages of the above-mentioned prior art device and system.

According to the invention, there is provided a remote access device comprising: a locking means, a communication means for receiving information from a remote location, a data entry means for enabling data input at the device, a data output means for enabling data output at the device, and a control means connected to each of the locking means, communication means, data entry means and the data output means.

There is also provided a method of operating a remote access system to enable goods to be delivered by a supplier to a customer, the customer having a remote access device as herein defined, the method including the following steps: {i} locating the remote access device at a fixed location; {ii} setting up a control station having a database of customers able to participate in the method; {iii} a customer places an order for the delivery of product(s) from a supplier; {iv} the supplier obtains an access code from the control station; {v} the control station transmits the same access code, and a separate delivery code, to the customer's remote access device; {vi} the delivery driver reaches the fixed location, and enters the access code into the remote access device by way of the data entry means; {vii} the control means of the remote access device compares the access code entered by the driver to that transmitted to it from the control station; {viii} if the access codes match, the control means issues an instruction to the locking means allowing the driver access to the fixed location; {ix} following access to the fixed location, the control means communicates the delivery code to the data output means.

Preferably the remote access device is fitted to a closed container ata fixed location, which may be provided specifically for the purpose of the temporary and secure storage of delivered products. Ideally, the only access to the closed container is through a panel the opening of which can be controlled by the locking means. Thus, the panel will normally be closed and locked, but can be unlocked by the remote access device so that access can be obtained to the container.

Alternatively, the remote access device is fitted an existing building such as a garage or part of a dwelling, the remote access device permitting access to the building (or at least to a secure part of the building).

The locking means is preferably electronically or electrically controlled, and can for example be a solenoid actuated means adapted selectively to activate and deactivate a mechanical lock. Accordingly, actuation of the locking means of the remote access device can permit access to the container or other fixed location. Thus, notwithstanding that the term “locking means” is used, the remote access device may not be the only locking device fitted to the container, and a mechanical locking device may be used, which mechancal locking device can be deactivated and activated by the locking means of the remote access device.

The communication device preferably includes a modem, and so can communicate by way of a telephone link with a remote site. Desirably the telephone link is a wireless link, though alternatively a cable or wire link can be provided. The provision of a communication device enables a control station to transmit an access code and delivery code to the remote access device, the delivery driver being required to know the access code to gain entry to the fixed location. Following the delivery the delivery code can be outputted to the data output means for recordal by the driver, which code can be used to confirm that a delivery has been made, and is therefore similar to a customer's “signature”.

Preferably, the data output means comprises a visual display means.

The driver can store the delivery code as proof that a delivery has been made, and can transmit the code this back to the supplier. The supplier can transmit the delivery code to the customer and/or to the control station for reporting to the customer. In this way, the customer can be informed that the delivery has been made, and the delivery driver receives confirmation that a delivery has been made. Alternatively, the communications means can transmit the delivery code (or other information confirming that the delivery has been made) directly to the control station as well as outputting this to the driver.

The data entry means preferably includes a key pad; ideally a numerical key pad, by which a series of numbers can be input to the device. The provision of a data entry means enables the delivery driver to enter the access code so as to gain access to the fixed location.

Preferably, all of the communications to and from the control station are made electronically by telephone link, perhaps by e-mail if appropriate. Accordingly, the control station can be located at a site which is remote from the customer and the supplier.

Usefully, the access code will permit only a one-off access to the fixed location, i.e. when the door or panel of the fixed location has been opened one time the remote access device will no longer respond to that access code. Accordingly, if the driver inadvertently allows the door or panel to close and become locked before the delivery is complete, a new access code will have to be obtained. If, for example, the fixed location is the customer's garage or dwelling, it is an important security feature that each access code only works once, and also that there will be a record of who has had knowledge of, and who has utilised, the access code. The provision of a unique access code for each delivery is a significant advantage over the device and system of Porter, since that access code will be of no benefit to an unscrupulous driver who might otherwise seek to return later to steal the delivered goods, and is of no benefit to an unlawful person who learns the access code.

In addition, it can be arranged that only a single delivery is made to a particular fixed location before the delivered goods can be retrieved, e.g. one delivery each working day. Thus, it may be desirable that only one supplier's delivery driver has access to the fixed location each day, to prevent the secure location becoming full and unable to accept further deliveries, and also to prevent a second delivery driver stealing some or all of the product(s) delivered by the first delivery driver. The use of a control station which issues unique access codes only when these are required permits some control over the timing and number of deliveries which can be made.

The control station will preferably have a database of customers having the remote access system for which it can issue access codes. The access codes may be generated randomly, or sequentially. Ideally, each access code is used only once, but this is not necessarily essential since if a large number of access codes are issued over time, over a large geographical area, the likelihood of any person other than the appointed delivery driver being able to match the access code for a particular location is very small.

Preferably also the delivery code is unique, ideally being random. The delivery code will only be displayed once the fixed location has been accessed, i.e. the locking means has been deactivated (and if necessary reactivated), so that the knowledge of the delivery code by the delivery driver can only be obtained if he or she has visited the customer's delivery address and accessed the fixed location.

### BRIEF DESCRIPTION OF THE DRAWINGS

The invention will now be described, by way of example, with reference to the accompanying drawings, in which;

FIG. 1 shows a dedicated container fitted with a remote access device according to the invention;

FIG. 2 is a schematic representation of the components of the remote access device; and

FIG. 3 is a schematic representation of the mechanical lock of the container of FIG. 1.

### DESCRIPTION OF THE EXEMPLARY EMBODIMENTS

The container 10 is adapted to be located at the customer's premises or other suitable fixed location. The container 10 is dedicated to this purpose, i.e. it is intended (solely) for the temporary and secure storage of a product or products delivered to the customer. The container 10 is therefore designed to be secure against tampering or unauthorised access, and will also be secured against its removal from the customer's premises. The only access to the container 10 is by way of a hinged panel or door 12. Secured to the container 10 is a remote access device 14, which remote access device controls access to the container 10. In this embodiment the remote access device is located within a recess in the door 12, but in other embodiments could be fitted to the surface of the door, or within or upon the container, perhaps adjacent the door.

In alternative embodiments, the remote access device can be fitted to an existing building such as a garage or entrance lobby or porch of the customer's premises, the remote access device allowing a delivery driver access to a secure part of that building to deliver the product or products.

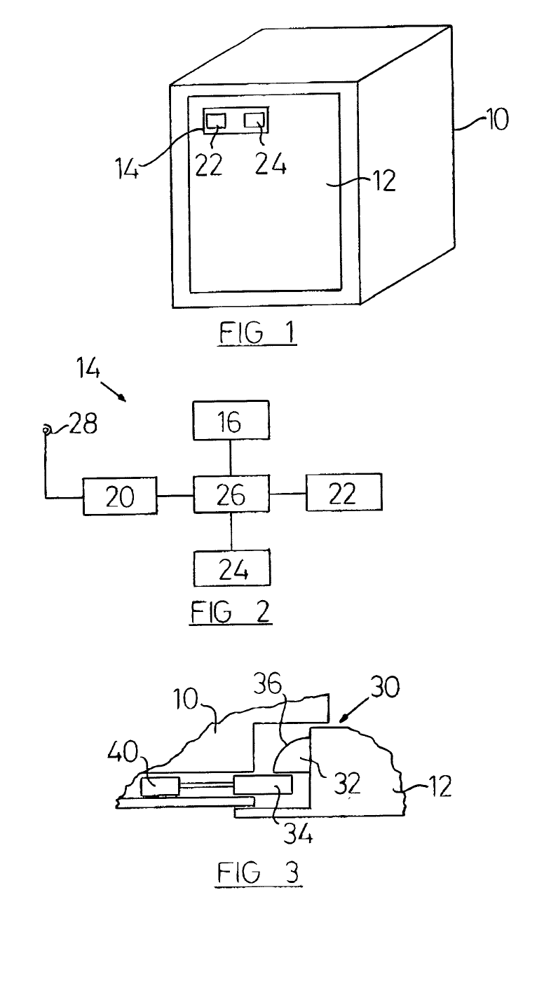

As shown in FIG. 2, the remote access device 14 comprises a locking means 16, a communication device 20, a data entry means 22, a data output or display means 24 and control means 26. As seen in FIG. 1, in this embodiment only the data entry means (in this embodiment in the form of a numerical key pad) 22 and the display means 24 are visible from the exterior of the container 10—the locking means 16, the communication device 20 and the control means 26 being hidden from view within the door 12 of the container 10.

As shown in FIG. 2, the control means 26 communicates by way of respective electrical wires with each of the other components of the remote access device (only one wire being shown between each component in this schematic representation). The control means 26 includes a memory and a processor, the processor being programmed {i} to store within the memory an access code and a delivery code transmitted to the remote access device by way of the communication device 20, {ii} to interrogate the memory and compare the access code stored therein with data input into the key pad 22, {iii} to transmit a signal to actuate the locking means 16 if the access codes match, and {iv} to transmit the delivery code to the display means 24 when the lock means 16 has been actuated.

If the access codes match the signal transmitted to actuate the locking means causes the locking means to deactivate the mechanical lock 30 (FIG. 3) of the container 10.

Also, the processor can be programmed to issue an error signal to the display means 24 if the access codes do not match. The system can permit the delivery driver a number of attempts to input the correct access code, so as to avoid the driver being “locked out” because of a failure to input the correct code first time. If the correct access code is not input after a predetermined number of attempts, the control means can be programmed not to respond to further attempts to enter the access code for a certain period of time, e.g. five minutes.

The communication means 20 in this embodiment is connected to an antenna 28, which can transmit and receive radio waves in the mobile telephone part of the spectrum. By way of the antenna and the communications means 20, information can be transmitted to the remote access system from the control station (not shown), and vice versa. In alternative embodiments, the antenna 28 is replaced by a fixed cable or wire link to the telephone network.

In a particularly preferred embodiment of the invention, the communication means includes a link to the customer's own fixed telephone line, and a diverting means is inserted into that line ahead of the customer's telephone to divert information intended for the remote access device. In a particularly preferred embodiment the diverting means includes a modem arranged in the telephone line “upstream” of the customer's telephone, which modem receives all of the signals passing along the telephone line. When it is desired to send an access code and a delivery code to the remote access device a short identifying signal is sent along the telephone line. It is arranged that the identifying signal is of very short duration, and in particular is too brief to cause the telephone bell to ring. The modem recognises the identifying signal. The information containing the access code and the delivery code is subsequently sent a short time after the identifying signal, and this is recognised by the modem as intended for the remote access device, and so can be immediately and completely diverted to the control means by way of the communication means. By using an initial identifying signal of very short duration, the remote access device can receive signals along the customer's telephone line without the inconvenience of the telephone bell ringing unnecessarily. In the absence of an identifying signal the modem does not react to an incoming signal, and allows it to pass to the customer's telephone in the normal way.

The ability to utilise the customer's telephone line avoids the requirement for a dedicated telephone link (e.g. a separate fixed telephone line or a mobile communications link) for the remote access device, which dedicated link will likely only be required periodically, and then only for short periods of time. This arrangement therefore avoids the fixed and periodic costs associated with a decidated telephone link.

Mains electrical power is supplied to the remote access device 14 by way of a fixed wire (not shown); if desired the remote access device can also have a battery to provide power in the event of an interruption in the mains supply.

As seen in FIG. 3, the mechanical lock 30 comprises a conventional bolt 32, which is locatable behind a strike plate 34. In known fashion, the bolt has a chamferred face 36 and is also resiliently biassed towards its extended position (as shown) so that when the door 12 is closed the chamferred face 36 engages the strike and the bolt is pushed back until it passes the strike. As such, the bolt 32 is a conventional latch bolt.

The locking means 16 communicates with a solenoid 40; activation of the solenoid 40 causes the strike plate 34 to be retracted which enables the door 12 to be opened. Such mechanical locks incorporating solenoid actuatable strike plates are known in remote access systems such as those of apartment blocks and the like, allowing each apartment owner remotely to open the entrance door. Whilst it would be possible that the locking means 16 communicates directly with the bolt, i.e. the bolt could itself be controlled by the solenoid, the control of the strike plate by way of the solenoid is generally preferred since following operation of the solenoid to allow the door to be opened, the door may subsequently be closed (and automatically secured) without further operation of the solenoid.

Though not shown in the drawings, the bolt 32 is preferably also operable by way of a conventional key, so that the customer can access the container without having to operate the remote access system, i.e. the owner can use a key to retract manually the bolt 32 so that it can pass the strike plate 34.

As indicated above, the data output means in this embodiment is a (visual) display means 24, specifically an L.E.D. numeric display, and has four panels each able to display a number; in this way the delivery code can be displayed as a four digit number. Alternatively, the display device can comprise only a single panel, the numbers of the delivery code being displayed in sequence thereon. In other embodiments, the display means (and also the data entry means) can allow the display (and entry) of letters as well as or instead of numbers

If desired, the container 10 can include contacts (such as magnetic contacts, for example) which can detect when the door 12 is closed, and it can be arranged that the delivery code is only transmitted to the display means when the door has been closed (and perhaps re-secured).

If the delivery code is displayed as soon as the door 12 is opened, it can be arranged that the delivery code is displayed for a fixed period of time, perhaps several minutes, allowing the delivery driver adequate time to complete the delivery and record the delivery code. Alternatively, it may be necessary for the delivery driver to press a control button before the delivery code is displayed, and to press the same or another button when the delivery code has been recorded.

As an alternative to the alpha-numeric data entry means, the remote access device can include a microphone and a tone recognition means, the access code being in the form of a series of audible (or perhaps non-audible) tones in a particular sequence (such as the tones of a “touch tone” telephone for example, with a particular tone for each number). The access code could be given to the delivery driver directly into a recording device which could record the sequence of tones and output them into the microphone of the remore access device when required. In this way, the delivery driver would not need to know the access code, but could merely replay the access code into the data entry means.

In a similar way, the display means could be replaced by a data output means able to issue a delivery code in the form of a sequence of tones which could subsequently be stored and/or reported to the supplier and/or control station.

Clearly, many alternative forms of data entry and data output could be used, as desired.

Whilst use of the device has been described primarily in relation to the delivery to an unoccupied private location having a single remote access device, it is conceived that banks of containers 10 could be provided in public locations such as shopping centre car parks, business car parks, or in a central location in a town or on a housing estate, for example, each container 10 being designated for a particular customer, and each container 10 having its own remote access device 14 In this way, deliveries could be made to a centralised delivery area convenient for the delivery company and the customer, and yet be secured there for an individual customer pending the subsequent collection by that customer. In an alternative embodiment, a centralised remote access device can control access to a number of containers in a bank, the locking means of the centralised remote access device being adapted to deactivate the mechanical lock of each individual container upon receipt of the appropriate command from the control station identifying the individual container which is to be accessed.

1. a remote access device comprising:
a locking means,
a communication means for receiving information from a remote location,
a data entry means for enabling data input at the device,
a data output means for enabling data output at the device,
and a control means connected to each of the locking means, communication means, data entry means and the data output means.

2. A remote access device according to claim 1 in which the data output means comprises a visual display means.

3. A remote access device according to claim 1 in which the communication means is adapted also to transmit information to a remote location.

4. A remote access device according to claim 1 in which the communication means includes a modem.

5. A remote access device according to claim 4 in which the modem can receive information from the remote location by way of a telephone link.

6. A remote access device according to claim 5 in which the telephone link comprises a telephone cable.

7. A remote access device according to claim 6 in which the telephone link includes diverting means, the diverting means having differentiating means able to differentiate information intended for the remote access device from other information carried by the link, the diverting means acting to divert information intended for the remote access device to the device.

8. A remote access device according to claim 1 fitted to a container at a fixed location, the container being provided for the temporary and secure storage of delivered products.

9. A remote access device according to claim 8 in which the container has an openable panel, the opening of the panel being controlled by the locking means.

10. A remote access device according to claim 1 fitted to a building, the remote access device permitting access to the building.

11. A remote access device according to claim 1 in which the locking means is electrically controlled.

12. A remote access device according to claim 1 in which the data entry means comprises a key pad.

13. A remote access device according to claim 12 in which the key pad is a numerical key pad by which a series of numbers can be input to the device.

14. A method of operating a remote access system to enable goods to be delivered by a supplier to a customer, the customer having a remote access device comprising:
a locking means,
a communication means for receiving information from a remote location,
a data entry means for enabling data input at the device,
a data output means for enabling data output at the device,
and a control means connected to each of the locking means, communication means, data entry means and the data output leans,
the method including the following steps:
{i} locating the remote access device at a fixed location;
{ii} setting up a control station having a database of customers able to participate in the method;
{iii} a customer places an order for the delivery of product(s) from a supplier;
{iv} the supplier obtains an access code from the control station;
{v} the control station transmits the same access code, and a separate delivery code, to the customer's remote access device;
{vi} the delivery driver reaches the fixed location, and enters the access code into the remote access device by way of the data entry means;
{vii} the control means of the remote access device compares the access code entered by the driver to that transmitted to it from the control station;
{viii} if the access codes match, the control means issues an instruction to the locking means allowing the driver access to the fixed location;
{ix} following access to the fixed location, the control means communicates the delivery code to the data output means.

15. A method of operating a remote access system according to claim 14 in which all of the communications to and from the control station are made electronically by telephone link, and in which the control station is located at a site which is remote from the customer and the supplier.

16. A method of operating a remote access system according to claim 14 in which the access code will permit only one-time access to the fixed location.

17. A method of operating a remote access system according to claim 14 in which each access code is used only once.

18. A method of operating a remote access system according to claim 14 in which the delivery code is unique.

19. A method of operating a remote access system according to claim 14 in which the access code and/or the delivery code are random.

20. A method of operating a remote access system according to claim 14 in which the delivery code is displayed only after the fixed location has been re-secured.
